(19) United States
(12) Patent Application Publication
(10) Pub. No.: US 2025/0140917 A1
(43) Pub. Date: May 1, 2025

(54) SOLID-STATE ELECTROLYTE AND LITHIUM-ION BATTERY

(71) Applicants: Cyntec Co., Ltd., Hsinchu (TW); National Tsing Hua University, Hsinchu (TW)

(72) Inventors: I-Sheng Wang, Hsinchu (TW); Wen-Hsuan Lu, Hsinchu (TW); Yen-Lin Chen, Hsinchu (TW); Han-Yi Chen, Hsinchu (TW)

(21) Appl. No.: 18/926,768

(22) Filed: Oct. 25, 2024

Related U.S. Application Data
(60) Provisional application No. 63/546,038, filed on Oct. 27, 2023.

(51) Int. Cl. H01M 10/0562; H01M 10/0525

(52) U.S. Cl. CPC H01M 10/0562; H01M 10/0525

(57) ABSTRACT

A solid-state electrolyte of a lithium-ion battery is provided. The lithium-ion battery has a negative electrode including a lithium-containing material in contact with the solid-state electrolyte. The solid-state electrolyte includes a multiple-doping material with a chemical formula of LiₓTi_{y}Mₘ(PO₄)₃, wherein 0.8≤x≤1.5, 0<y≤0.6, M represents at least three different doping elements, 1.25≤m≤1.7, and y/m≤0.5. The lithium-ion battery using the solid-state electrolyte is also provided.

### CROSS-REFERENCE TO RELATED APPLICATIONS

The present application is a nonprovisional application claiming benefit from a prior-filed provisional application bearing a Ser. No. 63/546,038 and filed Oct. 27, 2023, the entity of which is incorporated herein for reference.

### FIELD OF THE INVENTION

The present disclosure relates to a solid-state electrolyte, and particularly to an oxide-based solid-state electrolyte used in a lithium-ion battery.

### BACKGROUND OF THE INVENTION

Nowadays, rechargeable lithium-ion batteries have been highly developed and play an important role in the electrical energy storage field. The applications include, but not limiting, wearable electronic devices, consumer electronics and electric vehicles (EVs). The lithium-ion batteries have advantages of high energy density, long cycle life and low cost.

For safety issues, solid-state electrolytes are researched to substitute the liquid electrolytes in the lithium-ion batteries. Compared to the liquid electrolytes, the lithium-ion batteries using the solid-state electrolytes have advantages of high safety, no leakages of toxic solvents, no flammability and volatility, less short-circuiting, easy processability, small size and non-strict storage conditions. Therefore, efforts are made in researches of better materials of solid-state electrolytes. The classification of the solid-state electrolytes mainly includes polymer-based solid-state electrolytes, sulfide-based solid-state electrolytes and oxide-based solid-state electrolytes. The polymer-based solid-state electrolytes such as polyethylene oxide (PEO) or polyacrylonitrile (PAN) are dissatisfactory due to their low ionic conductivity, narrow electrochemical window and low chemical strength. The sulfide-based solid-state electrolytes such as thio-lithium superionic conductor (thio-LISICON), Li-argyrodite or LGPS have low moisture stability. Being exposed to air, a toxic hydrogen sulfide (H₂S) may be generated. Hence, the oxide-based solid-state electrolytes with relatively high ionic conductivity and chemical stability have greater competitiveness. More concretely, the lithium-ion batteries using the oxide-based solid-state electrolytes are good choices for portable terminals.

Na superionic conductor (NASICON), one type of the oxide-based solid-state electrolytes, has better ionic conductivity and insensibility to moisture and carbon dioxide. Hence, while adopting the NASICON-based solid-state electrolytes, the requirements and conditions for mass production of the lithium-ion batteries are not so strict. Taking lithium aluminum titanium phosphate Li_{1.3}Al_{0.3}Ti_{1.7}(PO₄)₃ (LATP) as an example, the titanium (IV) ions (Ti⁴⁺) on the surface of the LATP pellet 13 will react with the lithium metal of the negative electrode 11 of the battery so as to be reduced to titanium (III) ions (Ti³⁺) during the discharging process as shown in FIG. 1. With the loss of the titanium (IV) ions, the LATP solid-state electrolytes 13 gradually deteriorate from the surface in contact with the lithium metal 11. Also, lithium dendrites are formed and extend into the structure of the LATP pellet 13 as shown in FIG. 2 after certain charge cycles. These undesirable effects damage the structure and even cause cracks of the LATP pellet 13 so as to affect the cycle life of the batteries. Improvement in the materials is thus desired.

### SUMMARY OF THE INVENTION

An aspect of the present disclosure provides a solid-state electrolyte. The lithium-ion battery has a negative electrode including a lithium-containing material. The solid-state electrolyte includes a multiple-doping material with a chemical formula of LiₓTi_{y}Mₘ(PO₄)₃, wherein 0.85≤x≤1.5, 0<y≤0.6, M represents at least three different doping elements, 1.2≤m≤1.7, and y/m≤0.5.

In an embodiment, the multiple-doping material has disordered sublattices.

In an embodiment, M represents at least four different doping elements. In particular, the multiple-doping material is a high-entropy NASICON-type material.

In an embodiment, each doping element in the chemical formula is a metal element having an oxidation state of +2 to +6, particularly having an oxidation state of +3 to +6.

In an embodiment, each doping element in the chemical formula has an ionic radius not greater than 100 pm, and particularly has an ionic radius of 53-90 pm.

In an embodiment, the doping elements are Mg, Al, Ca, Sc, V, Zn, Ga, Ge, Y, Zr, Nb, Mo, In, Sn, Sb, Hf, Ta or W.

In an embodiment, the solid-state electrolyte has an ionic conductivity higher than 10⁻⁵ Scm⁻¹.

Another aspect of the present disclosure provides a lithium-ion battery. The lithium-ion battery includes a positive electrode, a negative electrode including a lithium-containing material, and the solid-state electrolyte described above. The solid-state electrolyte is disposed between the positive electrode and the negative electrode and in contact with the lithium-containing material.

In an embodiment, the negative electrode includes lithium metal or Li₄Ti₅O₁₂, and the positive electrode includes LiFePO₄, LiMn₂O₄, lithium nickel cobalt manganese oxide or lithium nickel cobalt aluminum oxide.

### BRIEF DESCRIPTION OF THE DRAWINGS

The advantages of the present disclosure will become more readily apparent to those ordinarily skilled in the art after reviewing the following detailed description and accompanying drawings, in which:

FIG. 1 is a schematic diagram showing that titanium (IV) ions in the LATP solid-state electrolytes are reduced to titanium (III) ions by lithium metal during a discharging process.

FIG. 2 is a schematic diagram showing deterioration of the LATP solid-state electrolytes in contact with the lithium metal of the negative electrode.

FIGS. 3A and 3B show cyclic voltammograms of Li_{1.3}Al_{0.4}Ti_{0.5}Zr_{0.5}Sn_{0.5}Ta_{0.1}(PO₄)₃ and LATP, respectively.

FIGS. 4A-4D show cyclic voltammograms of multiple-doping materials according to embodiments of the present disclosure.

FIGS. 5A and 5B are schematic diagrams showing diffusion tunnels for lithium ions between ordered and disordered sublattices, respectively.

FIG. 6 is an exploded view of a lithium-ion battery according to an embodiment of the present disclosure.

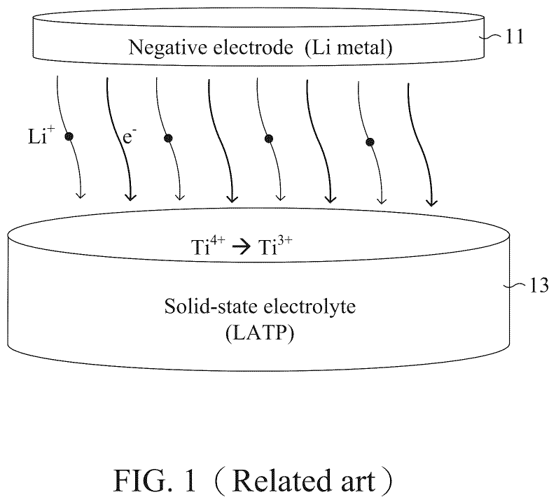

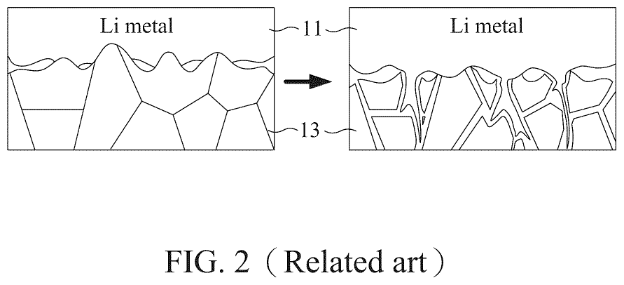

### DETAILED DESCRIPTION OF PREFERRED EMBODIMENTS

The present disclosure will now be described more specifically with reference to the following embodiments. It is to be noted that the following descriptions of preferred embodiments of this invention are presented herein for purpose of illustration and description only. It is not intended to be exhaustive or to be limited to the precise form disclosed.

The present disclosure provides solid-state electrolytes for use in lithium-ion batteries. The solid-state electrolytes include a multiple-doping material wherein the titanium component is partially substituted by doping specific elements so as to reduce the concentration of titanium (IV) ions. Thus, it inhibits or prevents titanium (IV) ions from a redox reaction with the lithium-containing material of the battery negative electrode, thereby slowing down or eliminating the deterioration process of the solid-state electrolytes. Further, this multiple-doping material still needs to maintain good ionic conductivity to ensure the charge/discharge efficiency of the lithium-ion batteries.

According to the present disclosure, the multiple-doping material has a general chemical formula of LiₓTi_{y}Mₘ(PO₄)₃. The conditions include that 0.8≤ lithium content x≤ 1.5, 0<titanium content y≤0.6, M represents at least three different doping elements other than the titanium element, 1.2≤ doping element content m≤ 1.7, and the content of the doping elements substituted for the titanium element are at least twice, or even three times or four times, the amount of the remaining titanium content (y/m≤0.5). The above contents are expressed in a molar basis. For maintaining good ion conductivity and similar lattice structure of lithium-based NASICON, the doping elements could be selected based on several principles. Firstly, the metal elements have an oxidation state similar to titanium (IV), and thus the doped metal elements in the lattice structure will be more stable. Titanium (IV) has an oxidation state of +4, so that the candidate metal elements could have an oxidation state of +2 to +6, or closer to +4, i.e. +3 to +6. Secondly, the metal elements have an ionic radius similar to titanium (IV). If the difference between the ionic radii of titanium and the selected metal element is too large, impurity phases are likely to precipitate during the preparation process. Titanium (IV) has an ionic radius of 67 pm, so that the candidate metal elements could have an ionic radius of not greater than 100 pm, or closer to 67 pm, i.e. 53 pm to 90 pm. Such selected metal elements can substitute for titanium (IV) in the lattices more effectively and the titanium content in the multiple-doping material can be well reduced.

According to the given conditions, the candidate metal elements include, for example, Magnesium (Mg (II) ion radius 72 pm), aluminum (Al (III) ion radius 53 pm), calcium (Ca (II) ion radius 100 pm), scandium (Sc (III) ion radius 74.5 pm), vanadium (V (II) ion radius 64 pm, V (IV) ion radius 58 pm, V (V) ion radius 54 pm), zinc (Zn (II) ion radius 74 pm), gallium (Ga (III) ion radius 62 pm), germanium (Ge (II) ion radius 73 pm, Ge (IV) ion radius 53 pm), yttrium (Y (III) ion radius 90 pm), zirconium (Zr (IV) ion radius 72 pm), niobium (Nb (III) ion radius 72 pm, Nb (IV) ion radius 68 pm, Nb (V) ion radius 64 pm), molybdenum (Mo (III) ion radius 69 pm, Mo (IV) ion radius 65 pm, Mo (V) ion radius 61 pm, Mo (VI) ion radius 59 pm), indium (In (III) ion radius 80 pm), tin (Sn (IV) ion radius 69 pm), antimony (Sb (III) ion radius 76 pm, Sb (V) ion radius 60 pm), hafnium (Hf (IV) ion radius 71 pm), tantalum (Ta (III) ion radius 72 pm, Ta (IV) ion radius 68 pm, Ta (V) ion radius 64 pm), tungsten (W (IV) ion radius 66 pm, W (V) ion radius 62 pm, W (VI) ion radius 60 pm). In some cases, the metal elements have fewer number of oxidation states are favorable to avoid the generation of multi-phase products that require further complicated purification steps. It is helpful to increase the possibility to obtain a single thermodynamic product and improves the purity and yield of the specific product.

At least three doping elements can be selected from the group to prepare LiₓTi_{y}M1ₘ₁M2ₘ₂M3ₘ₃(PO₄)₃, LiₓTi_{y}M1ₘ₁M2ₘ₂M3ₘ₃M4ₘ₄(PO₄)₃, and the like. The multiple-doping material with much more doping elements substituting for the titanium component is also possible, while the value of the content sum m ranges from 1.2 to 1.7. The values of m1, m2, m3, m4, . . . will change based on charge balance. For example, if an element with a higher oxidation state and an element with a lower oxidation state are selected, the element with the higher oxidation state may have a smaller proportion in the material. The synthesis method may be a wet chemical method (such as sol-gel process or co-precipitation process), a melting-quenching method, a solid-phase synthesis, or any other known method, but is not limited thereto. Several examples of the multiple-doping materials together with their properties are given below.

In an embodiment, four doping elements, i.e. aluminum (III), zirconium (IV), tin (IV) and tantalum (V) are selected. The synthesized multiple-doping material is identified by X-ray diffraction (XRD) to has a NASICON main phase, and is observed and analyzed through scanning electron microscopy (SEM) and energy-dispersive X-ray spectroscopy (EDS) to be determined as Li_{1.3}Al_{0.4}Ti_{0.5}Zr_{0.5}Sn_{0.5}Ta_{0.1}(PO₄)₃. The mole ratio of titanium to the doping metal elements is 0.33 (y/m=0.5/1.5=0.33). In other words, the doping metal elements are three times the amount of the titanium. This material has an ion conductivity reaching 1.32×10⁻⁴ Scm⁻¹.

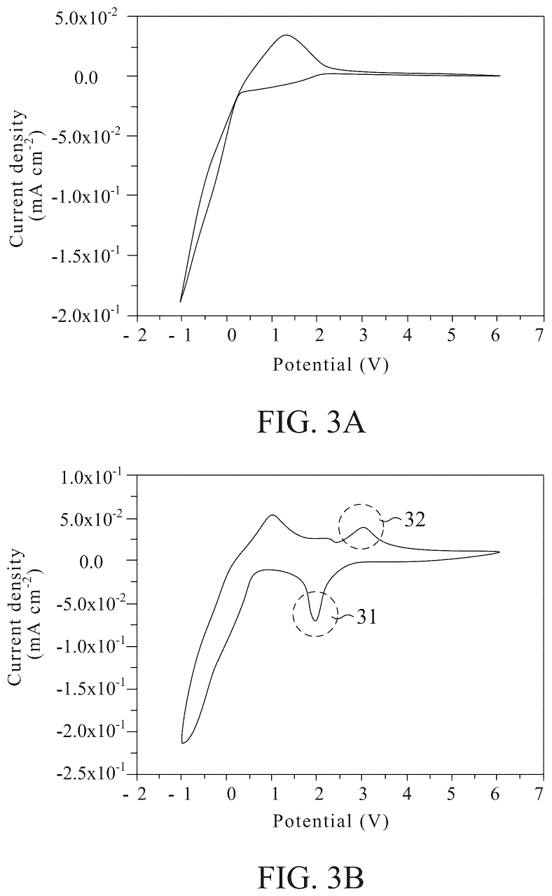

The redox behavior of this material and lithium metal with respective to applied voltage is measured by cyclic voltammetry (scan rate Im V/s). The obtained cyclic voltammetry trace is shown in FIG. 3A. Please also refer to the cyclic voltammetry trace corresponding to the LATP material of FIG. 3B. The LATP material has an obvious reduction peak (cathodic peak) 31 at 2.2V. At this time, the titanium (IV) ions are reduced to titanium (III) ions. It is noted that the oxidation peak (anodic peak) 32 is lower than the reduction peak 31, and it means that the titanium (IV) ions will gradually lose with deterioration of the LATP material. Compared with the LATP material, the similar reduction reaction at 2.2V is not observed in the cyclic voltammetry trace corresponding to the synthesized Li_{1.3}Al_{0.4}Ti_{0.5}Zr_{0.5}Sn_{0.5}Ta_{0.1}(PO₄)₃ of this disclosure. Therefore, this material can effectively inhibit the reaction between the titanium (IV) ions and the lithium metal and improve the stability of the solid-state electrolyte to the lithium metal. It can clearly be seen that the material is suitable for lithium-ion batteries.

In other embodiments, a variety of multiple-doping materials, using aluminum (III), zirconium (IV), yttrium (III), niobium (III), tantalum (V) or tungsten (VI), are prepared and provided, such as LiAl_{0.4}Ti_{0.4}Y_{0.4}Zr_{0.4}W_{0.4}(PO₄)₃,

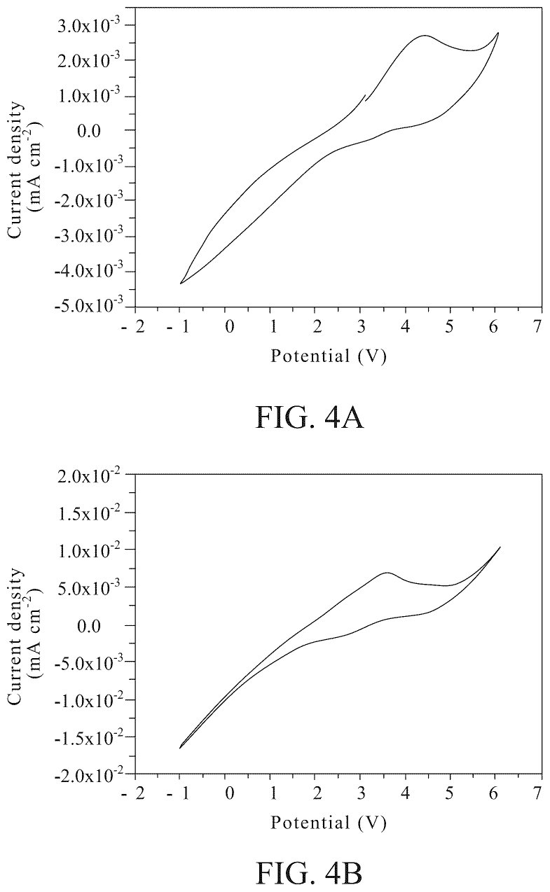

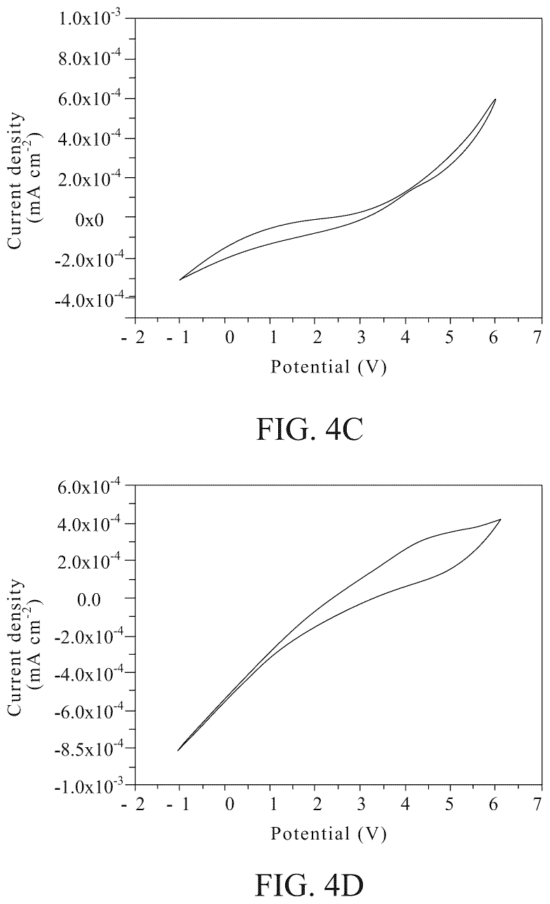

The mole ratio of titanium to the doping metal elements is reduced to 0.25 (y/m=0.25). Their XRD patterns show NASICON main phase, and their ionic conductivities approach 10⁻⁵ Scm⁻¹ level. The corresponding cyclic voltammetry traces are shown in FIGS. 4A-4D, respectively. It is observed that no obvious reduction reaction is measured at 2.2V, proving that it can effectively inhibit the reaction between the titanium (IV) ions and the lithium metal. Furthermore, the difference (ΔV) between the pair of the reduction peak 31 and the oxidation peak 32 of the LATP material is 1.04V (FIG. 3B). Observing the slight redox reaction relating to the prepared multiple-doping materials, the difference (AV) between the pair of peaks is about 1.35V-2.4V. The greater difference means that the reduction of the titanium (IV) ions is retarded and suppressed. These results show that the stability of the solid-state electrolytes to the lithium metal is improved. It renders these materials of the present disclosure applicable for lithium-ion batteries.

The present disclosure is not limited to NASICON-type materials. For example, even though the prepared multiple-doping materials having the doping elements selected according to the above-described conditions do not show NASICON main phase, the materials are also applicable for lithium-ion batteries when the stability to the lithium metal and ion conductivity of the solid-state electrolytes are satisfactory.

The above-described multiple-doping materials can be well adhered to the lithium metal, i.e. the negative electrode of the lithium-ion batteries, and no additional protection layer is needed to be disposed between the solid-state electrolyte and the negative electrode made of the lithium-containing material. Furthermore, because the multiple-doping materials are not sensitive to moisture and carbon dioxide in the air, it is advantageous to the production process/cost of the solid-state electrolytes and the lithium-ion batteries. It is to be noted that the present disclosure is not limited to the exact materials described in the above embodiments.

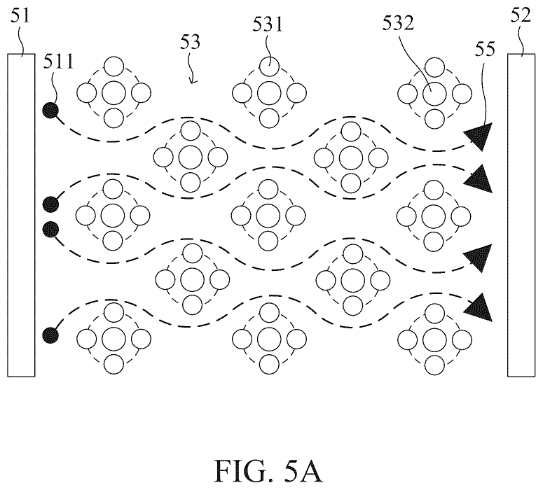

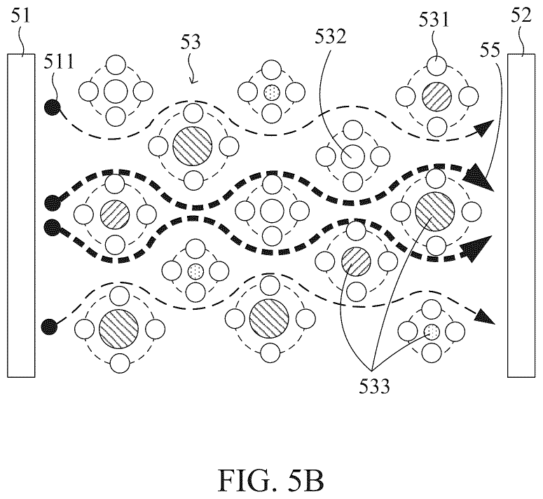

According to the concepts of the present disclosure, a high-entropy doping strategy is used to mix specific elements into a material to cause disorder in the material and from a most thermodynamically stable product. This product is simple and stable, and thus inhibits the occurrence of intermediate phase, so that a highly pure-phase product can be obtained. Please refer to FIGS. 5A and 5B, which are schematic diagrams showing diffusion tunnels for lithium ions between ordered and disordered sublattices, respectively. In FIG. 5A, the solid electrolyte 53, disposed between the negative electrode 51 and the positive electrode 52 of the lithium-ion battery, has ordered oxygen anion sublattices 531 and titanium cation sublattices 532. Diffusion tunnels 55 for the lithium ions 511 are formed between the MO₆ octahedra consisting of the sublattices 531 and 532. In FIG. 5B, the titanium cation sublattices 532 and the doping-metal cation sublattices 533 in the solid-state electrolyte 53 have different sizes. The oxygen anion sublattices 531 and the titanium cation sublattices 532/metal cation sublattices 533 present a disordered arrangement. The diffusion tunnels 55 for the lithium ions 511 are partially widened, and it prompts faster transfer of the lithium ions 511 in the solid-state electrolyte 53, thereby raising the ionic conductivity.

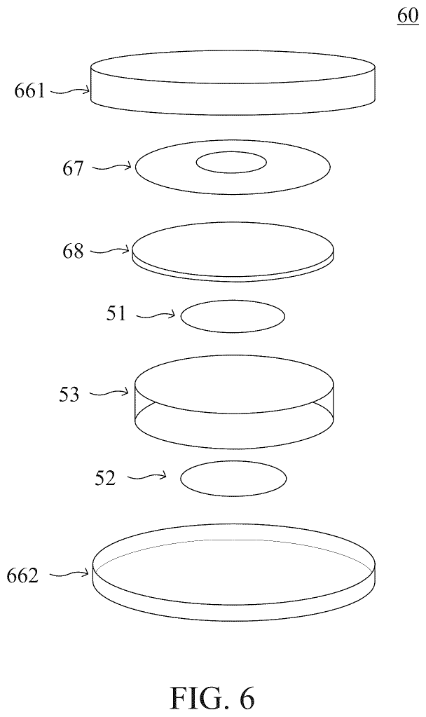

The present disclosure further provides an all-solid-state lithium-ion battery 60. Please refer to FIG. 6, which is an exploded view of the lithium-ion battery according to an embodiment of the present disclosure. The lithium-ion battery 60 basically includes a negative electrode 51, a positive electrode 52 and a solid-state electrolyte 53. The negative electrode 51 at least includes a lithium-containing material, and the solid electrolyte 53 is disposed between the positive electrode 52 and the negative electrode 51 and is in contact with the lithium-containing material. The solid-state electrolyte 53 in a pellet form includes a multiple-doping material having a general chemical formula of LiₓTi_{y}Mₘ(PO₄)₃, wherein 0.8≤x≤1.5, 0<y≤0.6, M represents at least three different doping elements, 1.2≤m≤1.7 and y/m≤0.5. The details have been described above, and any aforementioned multiple-doping material can be used herein. In an embodiment, the negative electrode 51 could include lithium metal or lithium titanate (Li₄Ti₅O₁₂), and the positive electrode 52 could include lithium iron phosphate (LiFePO₄, or called LFP), lithium manganate (LiMn₂O₄), lithium nickel cobalt manganese oxide (NCM) or lithium nickel cobalt aluminum oxide (NCA). It is to be noted that the materials of the negative electrode 61 and the positive electrode 62 are not limited to these examples.

The lithium-ion battery 60 can be designed in any known size. FIG. 6 shows one application. The combination of the negative electrode 51, the solid-state electrolyte 53 and the positive electrode 52 is placed in an accommodation space between an upper can 661 and a lower can 662. An elastic piece 67 and a spacer 68 are inserted to fix the relative positions. The resulting lithium-ion battery uses the solid-state electrolyte which is stable to lithium-containing material and insensitive to moisture/carbon dioxide. Hence, the durability of the lithium-ion batteries according to the present disclosure can be improved without introducing additional protection layer. The improvement reflects simplified manufacturing process and lower production cost. Also, the use of the solid-state electrolytes with good ion conductivity also enables good charge and discharge efficiency of the lithium-ion batteries.

While the disclosure has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A solid-state electrolyte of a lithium-ion battery having a negative electrode comprising a lithium-containing material, the solid-state electrolyte comprising a multiple-doping material with a chemical formula of LiₓTi_{y}Mₘ(PO₄)₃, wherein 0.8≤x≤1.5, 0<y≤0.6, M represents at least three different doping elements, 1.25≤m≤1.7, and y/m≤0.5.

2. The solid-state electrolyte according to claim 1, wherein the multiple-doping material has disordered sublattices.

3. The solid-state electrolyte according to claim 1, wherein M represents at least four different doping elements.

4. The solid-state electrolyte according to claim 3, wherein the multiple-doping material having the chemical formula of LiₓTi_{y}Mₘ(PO₄)₃, is a high-entropy NASICON-type material.

5. The solid-state electrolyte according to claim 1, wherein each of the doping elements in the chemical formula is a metal element having an oxidation state of +2 to +6.

6. The solid-state electrolyte according to claim 5, wherein the metal element has an oxidation state of +3 to +6.

7. The solid-state electrolyte according to claim 1, wherein each of the doping elements in the chemical formula has an ionic radius not greater than 100 pm.

8. The solid-state electrolyte according to claim 7, wherein each of the doping elements in the chemical formula has an ionic radius of 53-90 pm.

9. The solid-state electrolyte according to claim 1, wherein the doping elements are selected from a group consisting of Mg, Al, Ca, Sc, V, Zn, Ga, Ge, Y, Zr, Nb, Mo, In, Sn, Sb, Hf, Ta and W.

10. The solid-state electrolyte according to claim 1, wherein the solid-state electrolyte has an ionic conductivity higher than 10⁻⁵ Scm⁻¹.

11. A lithium-ion battery, comprising:
a positive electrode;
a negative electrode at least comprising a lithium-containing material; and
a solid-state electrolyte disposed between the positive electrode and the negative electrode and in contact with the lithium-containing material, the solid-state electrolyte comprising a multiple-doping material with a chemical formula of LiₓTi_{y}Mₘ(PO₄)₃, wherein 0.8≤x≤1.5, 0<y≤0.6, M represents at least three different doping elements, 1.2≤m≤1.7, and y/m≤0.5.

12. The lithium-ion battery according to claim 11, wherein the multiple-doping material has disordered sublattices.

13. The lithium-ion battery according to claim 11, wherein M represents at least four different doping elements.

14. The lithium-ion battery according to claim 13, wherein the multiple-doping material having the chemical formula of LiₓTi_{y}Mₘ(PO₄)₃, is a high-entropy NASICON-type material.

15. The lithium-ion battery according to claim 11, wherein each of the doping elements in the chemical formula is a metal element having an oxidation state of +2 to +6.

16. The lithium-ion battery according to claim 11, wherein each of the doping elements in the chemical formula has an ionic radius not greater than 100 pm.

17. The lithium-ion battery according to claim 11, wherein the doping elements are selected from a group consisting of Mg, Al, Ca, Sc, V, Zn, Ga, Ge, Y, Zr, Nb, Mo, In, Sn, Sb, Hf, Ta and W.

18. The lithium-ion battery according to claim 11, wherein the negative electrode comprises lithium metal or Li₄Ti₅O₁₂.

19. The lithium-ion battery according to claim 11, wherein the positive electrode comprises LiFePO₄, LiMn₂O₄, lithium nickel cobalt manganese oxide or lithium nickel cobalt aluminum oxide.
